(19) United States
(12) Patent Application Publication
(10) Pub. No.: US 2005/0099901 A1
(43) Pub. Date: May 12, 2005

(54) Optical device for reading information and method of determining mass-unbalance

(76) Inventors: Jeroen Arnoldus Leonardus Johannes Raaymakers, Eindhoven (NL); Herman Petrus Van Der Kall, Eindhoven (NL)

Correspondence Address: U S Philips Corporation;Intellectual Property Department, PO Box 3001, Briarcliff Manor, NY, 10510, US

(21) Appl. No.: 10/498,760

(22) PCT Filed: Dec. 16, 2002
(86) PCT No.: PCT/IB02/05457

(30) Foreign Application Priority Data
Dec. 19, 2001 (EP) 01205008.4

(51) Int. Cl. G11B 7/00

(52) U.S. Cl. 369/44.28; 369/53.25

(57) ABSTRACT

An optical playback or recording device is equipped with mass-unbalance detection means (20) for detecting unbalance on the record carrier (2). Mass-unbalance causes vibration and sound in the optical device when the record carrier (2) is rotated at a relative high speed. When mass-unbalance is detected, the speed may be reduced so as to reduce the vibration and sound in the optical device. Mass-unbalance is detected by using a state (T) of the carriage (5). The position of the carriage (5) in radial direction (D) is such a state (T). The current position of the carriage (5) is measured by an absolute measuring device. The amplitude of the difference (Pe) between the setpoint (W) and the current position of the carriage (5) is used to determine the mass-unbalance. There is a relation between the amplitude of the difference (Pe) and the amount of vibration caused by mass-unbalance. If mass-unbalance is detected, the speed of the rotation of the record carrier (2) may be reduced.

The invention relates to an optical device for reading information on a track on a surface of an optically readable record carrier to be placed therein, which device comprises:
rotation means for accommodating and rotating the record carrier at a rotational frequency fᵣ;
a radiation source for generating a radiation beam;
a carriage which is movable in a first direction transversely to the track and along the surface;
an objective for directing the radiation beam at the track, the objective being connected to the carriage;
an actuator for relative movement of the objective with respect to the carriage in said first direction;
state determining means for determining a state of the carriage, and
detection means for determining a mass-unbalance of the record carrier to be accommodated.

The invention further relates to a method of determining a mass-unbalance of an optically readable record carrier which is present in an optical device which is capable of reading information on a track of the record carrier, wherein the optical device comprises:
a carriage which is movable in a first direction transversely to the track and along the surface;
a radiation source for generating a radiation beam;
an objective for directing the radiation beam at the track, the objective being connected to the carriage;
an actuator for relative movement of the objective with respect to the carriage in said first direction,
   and wherein the method comprises the steps of:
rotating the record carrier at a rotational frequency fᵣ;
causing the radiation beam to follow the track, using said carriage and said actuator, and
determining a state of the carriage.

An embodiment of this optical device is known from EP-A-0 821 356.

In this known optical device, the mass-unbalance of the record carrier is detected by using a tracking error signal or a rotation control signal. The amplitude of the tracking error signal indicates the extent to which the actual position of the radiation beam is different from a desired position in the first direction. The rotation control signal determines the speed at which the rotation means rotate the record carrier.

If the mass of the record carrier is not homogeneously distributed relative to the center of rotation, mass-unbalance will occur. If a record carrier exhibiting mass-unbalance rotates at a high speed of, for example, 6000 rpm, vibrations may develop. Said vibrations may lead to variations in the distance between the part of the track covered by the radiation beam and the center of rotation. As a result, the amplitude of the tracking error signal may be higher than that of a record carrier which does not exhibit mass-unbalance. If the absolute value of the amplitude of the tracking error signal is higher than a predetermined second threshold value, this will be detected by the detection means of the known optical device. An absolute value of the tracking error signal in excess of the second threshold value indicates that the record carrier may exhibit mass-unbalance. The absolute value of the tracking error signal may also exceed the second threshold value if the track extends eccentrically around the center of rotation of the record carrier. Hereinafter the term sub-tracks will be used, a sub-track being a portion of the track which completely surrounds the center of the record carrier.

The known optical device has a hold-state. This is a condition in which part of the track is read repeatedly as a result of the radiation beam repeatedly jumping back to a sub-track preceding the current sub-track. If the record carrier exhibits mass-unbalance, the amplitude of the rotation control signal will be higher than in the case of a record carrier which does not exhibit mass-unbalance. The reason for this is that in the case of mass-unbalance the record carrier does not rotate uniformly between the positions between which the radiation beam jumps. The rotation controller attempts to even out the disturbance in the rotational speed ω that is caused by the mass-unbalance. As a result, the amplitude of the rotation control signal may be higher. The detection means of the known optical device detects the point at which the absolute value of the amplitude of the rotation control signal exceeds a predetermined second threshold value. An absolute value of the rotation control signal in excess of the second threshold value may indicate mass-unbalance of the record carrier. The detection means of the known optical device compares the amplitude of the rotation control signal with a predetermined threshold value. A value in excess of said threshold value means that the mass-unbalance of the record carrier is too great.

It is a first object of the invention to provide an optical device of the kind referred to in the introduction in which the detection means is capable of carrying out the determination of the mass-unbalance in an alternative way.

It is a second object of the invention to provide a method of the kind referred to in the introduction in which the detection of the mass-unbalance is carried out in an alternative way.

The first object is achieved with the optical device according to the invention in that the detection means are capable of using the state of the carriage for determining the mass-unbalance.

The state of the carriage may be the position of the carriage in radial direction, the speed of the carriage, the acceleration of the carriage, or a combination thereof.

If a record carrier exhibits mass-unbalance, vibrations may occur in the optical device, especially if relatively high rotational speeds are used. This may affect the state of the carriage. The vibrations effect a change in the position, the speed, or the acceleration of the carriage. Thus, the effect caused by the mass-unbalance can also be determined by determining the state of the carriage, and the state of the carriage can accordingly be used for the detection of mass-unbalance.

After the presence of mass-unbalance has been established, a subsequent step may be to reject the record carrier. Alternative subsequent steps are also possible, however, as will appear from a specific embodiment of the optical device.

In one embodiment of the optical device, the state determining means comprise an absolute measuring system for determining a current position of the carriage in the first direction, wherein the state comprises the current position of the carriage, and wherein the optical device further comprises difference determining means for defining a position error signal by determining a difference between the current position of the carriage and a desired position of the carriage, the detection means being capable of using the position error signal of the carriage for determining the mass-unbalance.

This embodiment can be readily implemented in existing optical devices. Existing optical devices frequently comprise an absolute measuring system for determining the current position of the carriage in radial direction. Said optical devices use the position tracking signal for controlling the position of the carriage. Vibrations resulting from mass-unbalance may make it more difficult to control the position of the carriage and cause the amplitude of the position error signal to become higher.

In a further implementation of this embodiment of the optical device, the detection means comprise steps for determining a maximum rotational frequency fₘ at which an amplitude E derived from the position error signal is lower than a first threshold value.

Since the amount of vibrations is greater at relatively high rotational speeds than at relatively low rotational speeds, said vibrations have a greater influence on the performance of the optical device as regards track following at higher rotational speeds. In addition, sound is produced in the optical device as a result of said vibrations, which is undesirable. The rotational frequency cannot be increased without limitation, therefore. There will be a maximum rotational frequency at which the optical device is still capable of functioning properly. The amplitude E may be an absolute value of the amplitude of the position error signal, for example. Since the amplitude of the position error signal depends in part on the vibrations caused by mass-unbalance, it is possible to determine the maximum rotational frequency fₘ by comparing the amplitude E with the first threshold value. If a record carrier exhibiting relatively little mass-unbalance, or none at all, is present in the device, there is a possibility that the aforesaid effect will not occur even if the record carrier is rotated at the maximally attainable rotational frequency fₘₐₓ. The maximum rotational frequency fₘ is equal to the maximally attainable rotational frequency fₘₐₓ in that case. The determination of the maximum rotational frequency fₘ may take place by starting from a relatively low rotational frequency and subsequently increasing said frequency to a maximum rotational frequency fₘ at which the amplitude E is lower yet than the first threshold value. It is alternatively possible to start with a relatively high rotational frequency and subsequently decrease it to a maximum rotational frequency at which the amplitude E is lower than the first threshold value.

In a modification of this embodiment of the optical device, the detection means comprises:
first filter means for delivering a filtered signal comprising the position error signal, in which components having a frequency lower than a first frequency are suppressed, which first frequency is lower than the rotational frequency fᵣ, and
amplitude determining means for determining the amplitude E from the filtered signal.

The position error signal may contain a DC component. If the amplitude E is directly the amplitude of the position error signal, as in the aforesaid embodiment, and said amplitude is compared with the first threshold value, the detection of the mass-unbalance will not function optimally as a result of the presence of the DC component. The fact is that the vibrations caused by mass-unbalance have relatively little influence on the DC component. An improved detection is obtained when the position error signal is filtered first, as a result of which the DC component will be suppressed. The amplitude determining means subsequently determine the amplitude of the first filtered signal. This amplitude is thus the aforesaid amplitude E derived from the position error signal, which is compared with the first threshold value by the detection means. The amplitude determining means can determine the amplitude E by determining a maximum value and a minimum value of the amplitude of the filtered signal and subsequently subtracting the minimum value from the maximum value. It is alternatively possible to determine the absolute value of the amplitude of the first filtered signal and subsequently determine the average of said absolute value so as to obtain the amplitude E.

The second objective is achieved with the method according to the invention in that the method uses the state for determining the mass-unbalance.

In one embodiment of this method, the optical device further comprises an absolute measuring system for determining a current position of the carriage, in which the state comprises the position of the carriage in the first direction, which method comprises a further step of determining a position error signal of the carriage by determining a difference between the current position of the carriage and a desired position of the carriage, the method using the position error signal for determining the mass unbalance.

In one implementation of this embodiment, the method comprises further steps for determining the maximum rotational frequency fₘ at which an amplitude E derived from the position error signal is lower than a first threshold value. If the amplitude E has a value lower than the first threshold value, the influence of the disturbances will be limited. In the case of rotational frequencies at which the amplitude E is lower than the first threshold value, the optical device will experience little difficulty in reading the information on the record carrier and, in addition, the extent to which sound is produced will be limited. It is advantageous to determine the maximum rotational frequency fₘ at which the amplitude E is lower than the first threshold value and at which accordingly the influence of the disturbances is limited.

In a modification of this embodiment, the method comprises farther steps of:
filtering the position error signal, whereby components having a frequency lower than a first frequency are suppressed, which first frequency is lower than the rotational frequency fᵣ, and
determining the amplitude E from the filtered signal.

The above and further aspects of the optical device according to the invention will be explained in more detail hereinafter with reference to the drawings, in which

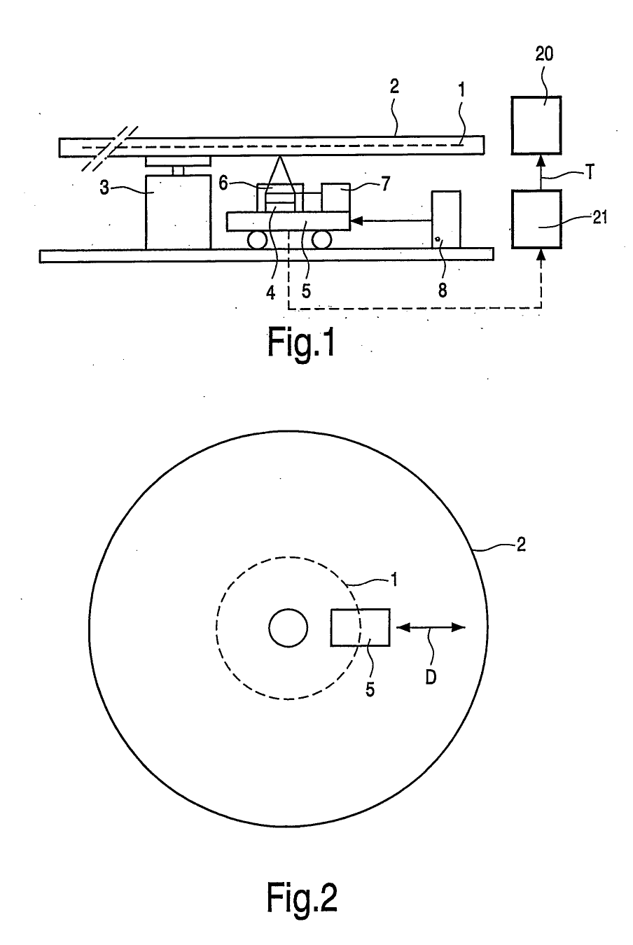

FIG. 1 shows an embodiment of the optical device with a record carrier present therein;

FIG. 2 shows the record carrier and the carriage in top plan view;

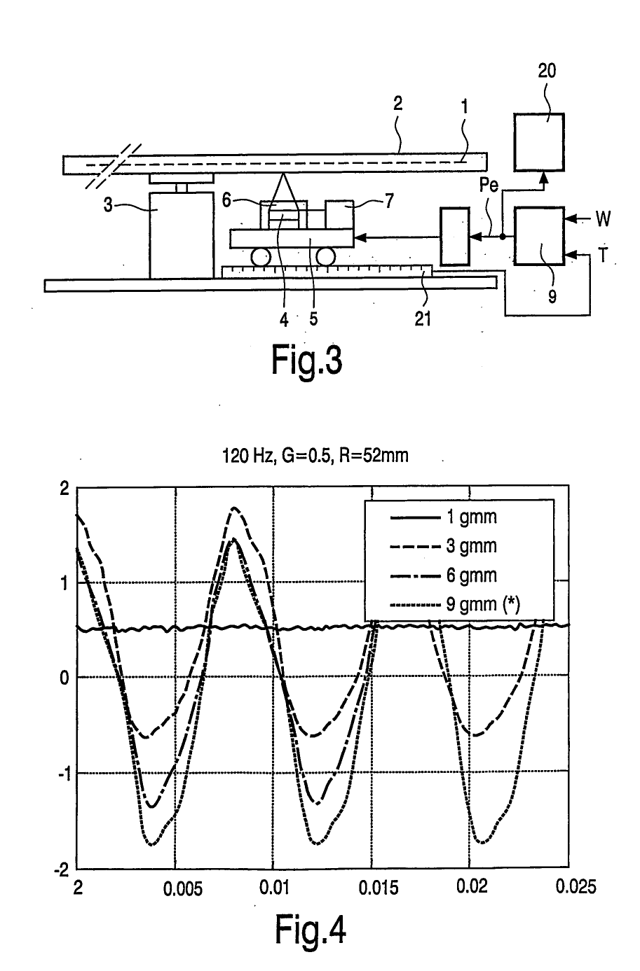

FIG. 3 shows an embodiment of the optical device comprising an absolute measuring system;

FIG. 4 shows a diagram of the position error signal as a function of time for four different record carriers exhibiting different degrees of mass-unbalance;

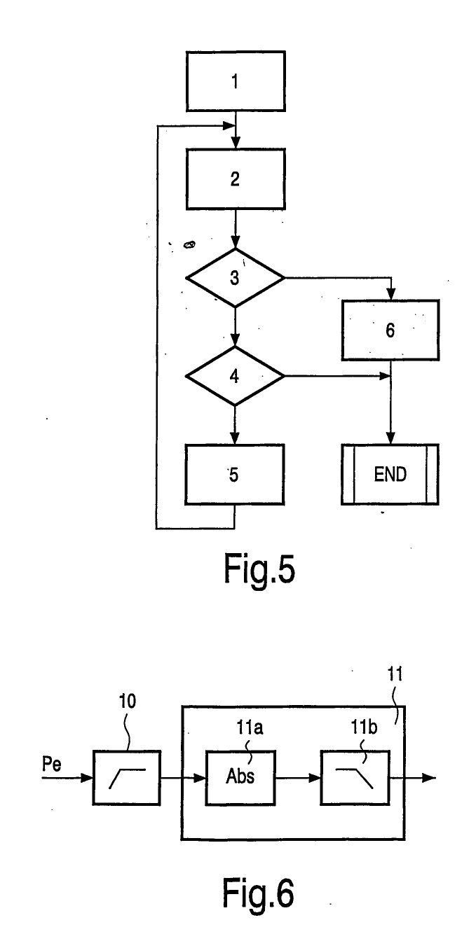

FIG. 5 shows an implementation of the steps which the detection means can carry out for determining the maximum rotational frequency fₘ; and

FIG. 6 shows an embodiment of the detection means.

FIG. 1 shows a record carrier 2, on which a track 1 is present. The track 1 contains information which can be read by the optical device. Furthermore, a rotation means 3 is present. The radiation source 4 generates a radiation beam. The carriage 5 is movable in the first direction D, see FIG. 2. The objective 6 is connected to the carriage 5. The actuator 7 can move the objective 6 in the first direction D. The state determining means 21 determine the state of the carriage 5. The state of the carriage 5 may be the position of the carriage 5 in the first direction D, for example, or alternatively the speed at which the carriage 5 moves in said direction, or a combination of position and speed. The first direction D is indicated by arrow D in FIG. 2. Hereinafter, the first direction D will also be referred to as the radial direction.

FIG. 3 shows an embodiment of the optical device in which the state determining means 21 comprise an absolute measuring system. Said measuring system measures the absolute position of the carriage 5 in radial direction. The difference determining means 9 defines the position error signal Pe, which is the difference between the desired position W of the carriage 5 and the absolute position of carriage 5. The detection system 20 determines mass-unbalance by means of the position error signal Pe. The position error signal Pe is also used for controlling the carriage 5 to a desired position.

In an experiment, four record carriers 2 exhibiting different degrees of mass-unbalance were tested. In the diagram of FIG. 4, the position error signal Pe is plotted on the vertical axis as a function of time for each record carrier 2. The record carriers 2 were rotated at a rate of 120 Hz. In the case of the lowest mass-unbalance of one gmm, the amplitude of the position error signal Pe is very low. The amplitude of the position error signal Pe increases as the mass-unbalance increases. A comparison of the amplitude of the position error signal Pe with the first threshold value makes it possible to determine whether the influence of mass-unbalance is not too great. If it is concluded that the influence of mass-unbalance is too great, it can be decided to rotate at a lower rotational speed. The influence of mass-unbalance is reduced in this way.

An example of the steps which the detection means 20 can carry out so as to determine the maximum rotational frequency fₘ at which the amplitude E is lower than the first threshold value is shown in FIG. 5.

In FIG. 5, step 1 comprises: rotating the record carrier 2 at a rotational frequency f; causing the radiation beam to follow the track 1, using the actuator 7 and the carriage 5.

Step 2 comprises the determination of the amplitude Pe.

In step 3, the amplitude Pe is compared with the first threshold value. If the amplitude Pe is higher than said threshold value, the next step will be step 6, if it is not, the next step will be step 4.

In step 4, the current rotational frequency fᵣ is compared with the maximally attainable rotational frequency fₘₐₓ. The rotation means 3 is not capable of realizing rotational speeds fᵣ higher than the maximally attainable rotational frequency fₘₐₓ.

In step 5, the rotational frequency fᵣ is increased by a value delta, and the detection means 20 causes the radiation beam to follow the track 1, using the actuator 7 and the carriage 5. The next step is step 2.

In step 6, the rotational frequency fᵣ is decreased by said value delta.

In the steps that are shown in FIG. 5, the rotational frequency fᵣ is increased with every step. An alternative solution is to follow a similar procedure, with this difference that the rotational frequency fᵣ is decreased with every step.

The diagram of FIG. 4 also clearly shows that a DC component in the position error signal Pe can play a role in the comparison of the amplitude of the position error signal Pe with the first threshold value. In the embodiment of the optical device shown in FIG. 6, the first filter means 10 filters the position error signal Pe, which results in the removal of the DC component. The filtered signal FS is fed to the amplitude determining means 11. In this embodiment, the amplitude E is determined by first having a processing unit 11a determine the absolute value of the amplitude of the filtered signal FS and subsequently pass the processed signal through a second filter 11b. The second filter 11b is a low-pass filter. In this way, an average of the processed signal, as it were, is obtained. The amplitude determining means 11 can also be realized in different ways, as already mentioned before.

1. An optical device for reading information on a track on a surface of an optically readable record carrier (2) to be placed therein, which device comprises:
rotation means (3) for accommodating and rotating the record carrier (2) at a rotational frequency fᵣ;
a radiation source (4) for generating a radiation beam;
a carriage (5) which is movable in a first direction (D) transversely to the track and along the surface;
an objective (6) for directing the radiation beam at the track (1), the objective (6) being connected to the carriage (5);
an actuator (7) for relative movement of the objective (6) with respect to the carriage (5) in said first direction (D);
state determining means (21) for determining a state (T) of the carriage (5), and
detection means (21) for determining a mass-unbalance of the record carrier (2) to be accommodated,
characterized in that said detection means (20) are capable of using the state (T) of the carriage for determining the mass-unbalance.

2. An optical device as claimed in claim 1, characterized in that the state determining means (21) comprise an absolute measuring system for determining a current position of the carriage (5) in the first direction (D), wherein the state (T) comprises the current position of the carriage (5), and wherein the optical device further comprises difference determining means (9) for defining a position error signal (Pe) by determining a difference between the current position of the carriage (5) and a desired position (W) of the carriage (5), said detection means (20) being capable of using the position error signal (Pe) of the carriage (5) for determining the mass-unbalance.

3. An optical device as claimed in claim 2, characterized in that the detection means (20) comprise steps for determining a maximum rotational frequency fₘ at which an amplitude E derived from the position error signal (Pe) is lower than a first threshold value.

4. An optical device as claimed in claim 3, characterized in that the detection means (20) comprises:
first filter means (10) for delivering a filtered signal (FS) comprising the position error signal (Pe), in which components having a frequency lower than a first frequency are suppressed, which first frequency is lower than the rotational frequency fᵣ, and
amplitude determining means (11) for determining the amplitude E from the filtered signal (FS).

5. A method of determining mass-unbalance of an optically readable record carrier (2) which is present in an optical device which is capable of reading information on a track (1) of the record carrier (2), which optical device comprises:
a carriage (5) which is movable in a first direction (D) transversely to the track and along the surface;
a radiation source (4) for generating a radiation beam;
an objective (6) for directing the radiation beam at the track (1), the objective (6) being connected to the carriage (5);
an actuator (7) for relative movement of the objective (6) with respect to the carriage (5) in said first direction (D),
said method comprising the steps of:
rotating the record carrier (2) at a rotational frequency fᵣ;
causing the radiation beam to follow the track (1), using said carriage (5) and said actuator (7), and
determining a state (T) of the carriage (5),
characterized in that the method uses said state (T) for determining the mass-unbalance.

6. A method as claimed in claim 5, characterized in that the optical device further comprises an absolute measuring system for determining a current position of the carriage (5), wherein the state (T) comprises the position of the carriage (5) in the first direction (D), and wherein the method comprises a further step of determining a position error signal (Pe) of the carriage (5) by determining a difference between the current position of the carriage (5) and a desired position of the carriage (5), which method uses the position error signal (Pe) for determining the mass unbalance.

7. A method as claimed in claim 6, characterized in that the method comprises further steps for determining the maximum rotational frequency fₘ at which an amplitude E derived from the position error signal (Pe) is lower than a first threshold value.

8. A method as claimed in claim 7, characterized in that the method comprises further steps of:
filtering the position error signal (Pe), whereby components having a frequency lower than a first frequency are suppressed, which first frequency is lower than the rotational frequency fᵣ, and
determining the amplitude E from the filtered signal (FS).
